(19) United States
(12) Patent Application Publication
(10) Pub. No.: US 2010/0114617 A1
(43) Pub. Date: May 6, 2010

(54) DETECTING POTENTIALLY FRAUDULENT TRANSACTIONS

(75) Inventors: Russell P. Bobbitt, Pleasantville, NY (US); Quanfu Fan, Somerville, MA (US); Sharathchandra U. Pankanti, Darien, CT (US); Akira Yanagawa, New York, NY (US); Yun Zhai, White Plains, NY (US)

Correspondence Address: Keohane & D'Alessandro, 1881 Western Avenue Suite 180, Albany, NY, 12203, US

(73) Assignee: INTERNATIONAL BUSINESS MACHINES CORPORATION, Armonk, NY (US)

(21) Appl. No.: 12/261,256

(22) Filed: Oct. 30, 2008

(51) Int. Cl. G08B 31/00; G06Q 10/00

(52) U.S. Cl. 705/7; 340/540; 705/30; 705/21

(57) ABSTRACT

An approach that detects potentially fraudulent transactions is provided. In one embodiment, there is a fraud detection tool including, an identification component configured to identify a first person present within a zone of interest at a point of sale (POS) device using a set of sensor devices; a transaction component configured to determine whether the POS device has performed a first transaction and a second transaction while the first person is present within the zone of interest at the POS device; an analysis component configured to: analyze a transaction type of the first transaction and the second transaction; and detect whether the second transaction is potentially fraudulent based on a determination of whether the POS device has performed a first transaction and a second transaction while the first person is within the zone of interest at the POS device, and an analysis of the transaction type of the second transaction.

### FIELD OF THE INVENTION

The present invention generally relates to point-of-sale (POS) transactions. Specifically, the present invention provides a way to improve security of POS transactions for increased loss prevention.

### BACKGROUND OF THE INVENTION

Shopping checkout (e.g., retail, supermarket, etc.) is a process by which most everyone is familiar. Typical checkout involves a shopper navigating about a store collecting items for purchase. Upon completion of gathering the desired item(s), the shopper will proceed to a point-of sale (POS) checkout station for checkout (e.g., bagging and payment). POS systems are used in supermarkets, restaurants, hotels, stadiums, casinos, as well as almost any type of retail establishment, and typically include separate functions that today are mostly lumped together at a single POS station: (1) enumerating each item to be purchased, and determining its price (typically, by presenting it to a bar code scanner), and (2) paying for all the items.

Unfortunately, with increased volumes of shoppers and instances of employee collusion, theft is growing at an alarming rate, as it is difficult to detect potentially fraudulent transactions using visual cues only. For example, in one case, a cashier may perform a regular and legitimate transaction for a customer. While the customer is still present at the check-out, the cashier may start another transaction (e.g., open the just-finished transaction with or without the customer's knowledge) and refund one or more items to the cashier's own pocket.

One current approach to solving this problem includes data-mining a transaction log that monitors all transactions from the POS station, including performing a query to retrieve refunds/voids after corresponding transactions with temporal thresholds. However, this approach does not provide real-time alerts, and it may provide excessive false alarms. Another current approach uses human surveillance to monitor cashiers. However, this solution is labor-intensive and may provide varying results.

### SUMMARY OF THE INVENTION

In one embodiment, there is a method for detecting fraudulent transactions. In this embodiment, the method comprises: identifying a first person present within a zone of interest at a point of sale (POS) device using a set of sensor devices; determining whether the POS device has performed a first transaction and a second transaction while the first person is present within the zone of interest at the POS device; analyzing a transaction type of the first transaction and the second transaction; and detecting whether the second transaction is potentially fraudulent based on the determining and the analyzing.

In a second embodiment, there is a system for detecting fraudulent transactions. In this embodiment, the system comprises at least one processing unit, and memory operably associated with the at least one processing unit. A fraud detection tool is storable in memory and executable by the at least one processing unit. The fraud detection tool comprises: an identification component configured to identify a first person present within a zone of interest at a point of sale (POS) device using a set of sensor devices; a transaction component configured to determine whether the POS device has performed a first transaction and a second transaction while the first person is present within the zone of interest at the POS device; an analysis component configured to: analyze a transaction type of the first transaction and the second transaction, and detect whether the second transaction is potentially fraudulent based on a determination of whether the POS device has performed a first transaction and a second transaction while the first person is present within the zone of interest at the POS device, and an analysis of the transaction type of the second transaction.

In a third embodiment, there is a computer-readable medium storing computer instructions, which when executed, enables a computer system to detect fraudulent transactions, the computer instructions comprising: identifying a first person present within a zone of interest at a point of sale (POS) device using a set of sensor devices; determining whether the POS device has performed a first transaction and a second transaction while the first person is present within the zone of interest at the POS device; analyzing a transaction type of the first transaction and the second transaction; and detecting whether the second transaction is potentially fraudulent based on the determining and the analyzing.

In a fourth embodiment, there is a method for deploying a fraud detection tool for use in a computer system that detects of fraudulent transactions. In this embodiment, a computer infrastructure is provided and is operable to: identify a first person present within a zone of interest at a point of sale (POS) device using a set of sensor devices; determine whether the POS device has performed a first transaction and a second transaction while the first person is present within the zone of interest at the POS device; analyze a transaction type of the first transaction and the second transaction; and detect whether the second transaction is potentially fraudulent based on a determination of whether the POS device has performed a first transaction and a second transaction while the first person is within the zone of interest at the POS device, and an analysis of the transaction type of the second transaction.

### BRIEF DESCRIPTION OF THE DRAWINGS

FIG. 1 shows a schematic of an exemplary computing environment in which elements of the present invention may operate;

FIG. 2 shows a fraud detection tool that operates in the environment shown in FIG. 1; and

FIG. 3 shows an overhead view from a sensor device of an exemplary POS device that operates with the fraud detection tool shown in FIG. 2.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to automatically detecting potentially fraudulent transactions in real-time using both visual information and point of sale (POS) input to detect multiple transactions at a POS for the same person (e.g., a customer). In these embodiments, a fraud detection tool provides this capability. Specifically, the fraud detection tool comprises an identification component configured to identify a first person present within a zone of interest at a POS device using a set (i.e., one or more) of sensor devices. The fraud detection tool further comprises a transaction component configured to determine whether the POS device has performed a first transaction and a second transaction while the first person is present within the zone of interest at the POS device. An analysis component is configured to analyze a transaction type of the first transaction and the second transaction, and determine whether the second transaction is potentially fraudulent based on a determination of whether the POS device has performed a first transaction and a second transaction while the first person is within the zone of interest at the POS device, and the analysis of the transaction type of the second transaction.

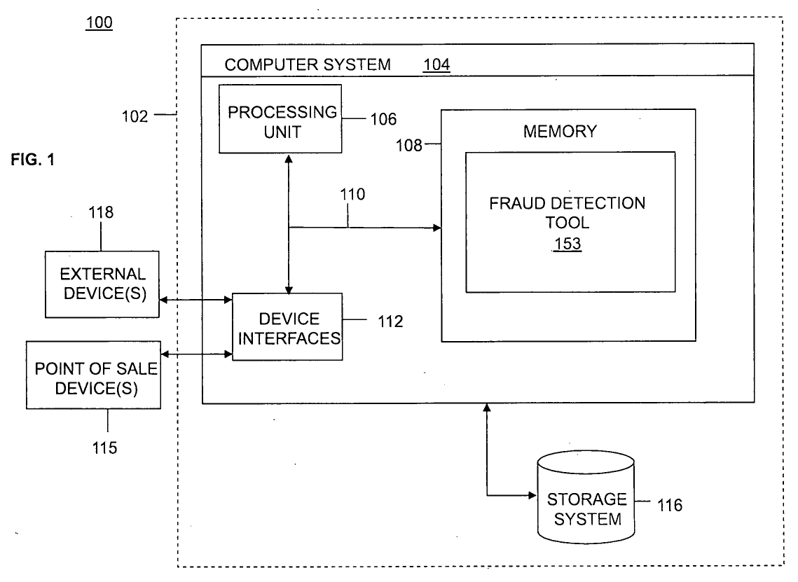

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for detecting potentially fraudulent transactions at a POS device. It should be understood that any other computers implemented under the present invention may have different components/software, but will perform similar functions. As shown, computer system 104 includes a processing unit 106 capable of analyzing image data and POS data, and producing a usable output, e.g., compressed video and video meta-data. Also shown is memory 108 for storing a fraud detection tool 153, a bus 110, and device interfaces 112.

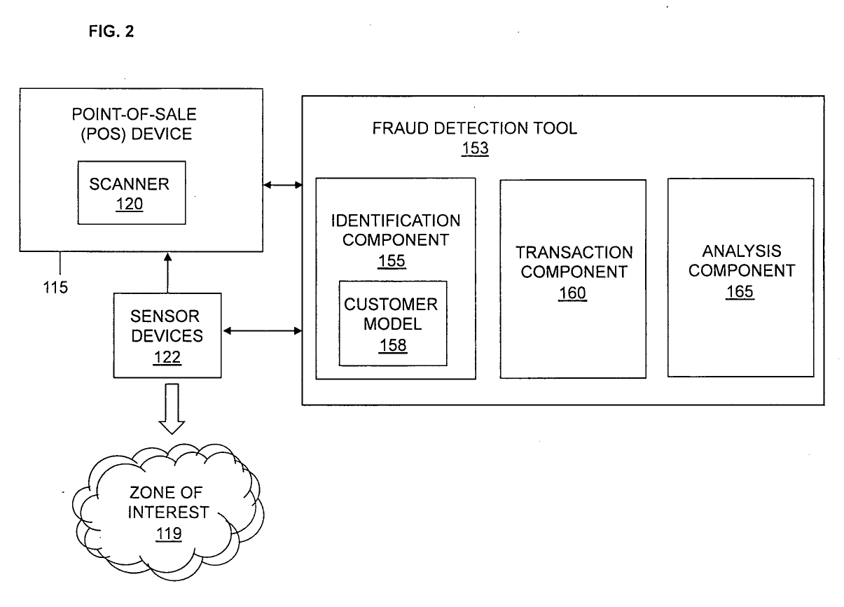

Computer system 104 is shown communicating with one or more sensor devices 122 and a POS device 115 that communicate with bus 110 via device interfaces 112. As shown in FIG. 2, POS device 115 includes a scanner 120 for reading printed barcodes that correspond to items, products, etc., using known methodologies. Sensor devices 122 includes a set (i.e., one or more) of sensor devices for capturing image data representing visual attributes of objects (e.g., people) within a zone of interest 119. Sensor devices 122 can include any type of sensor capable of capturing visual attributes of objects, such as, but not limited to: optical sensors, infrared detectors, thermal cameras, still cameras, analog video cameras, digital video cameras, or any other similar device that can generate sensor data of sufficient quality to support the methods of the invention as described herein.

Processing unit 106 collects and routes signals representing outputs from POS device 115 and sensor devices 122 to fraud detection tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the video signals may be encrypted using, for example, trusted key-pair encryption. Different sensor systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)). In some embodiments, POS device 115 and sensor devices 122 are capable of two-way communication, and thus can receive signals (to power up, to sound an alert, etc.) from fraud detection tool 153.

In general, processing unit 106 executes computer program code, such as program code for operating fraud detection tool 153, which is stored in memory 108 and/or storage system 116. While executing computer program code, processing unit 106 can read and/or write data to/from memory 108 and storage system 116. Storage system 116 stores POS data and sensor data, including video metadata generated by processing unit 106, as well as rules against which the metadata is compared to identify objects and attributes of objects present within zone of interest 119. Storage system 116 can include VCRs, DVRs, RAID arrays, USB hard drives, optical disk recorders, flash storage devices, image analysis devices, general purpose computers, video enhancement devices, de-interlacers, scalers, and/or other video or data processing and storage elements for storing and/or processing video. The video signals can be captured and stored in various analog and/or digital formats, including, but not limited to, Nation Television System Committee (NTSC), Phase Alternating Line (PAL), and Sequential Color with Memory (SECAM), uncompressed digital signals using DVI or HDMI connections, and/or compressed digital signals based on a common codec format (e.g., MPEG, MPEG2, MPEG4, or H.264).

Although not shown, computer system 104 could also include I/O interfaces that communicate with one or more external devices 118 that enable a user to interact with computer system 104 (e.g., a keyboard, a pointing device, a display, etc.).

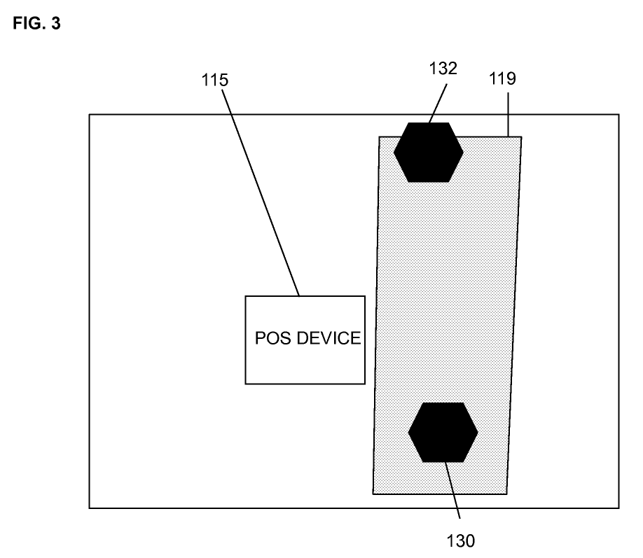

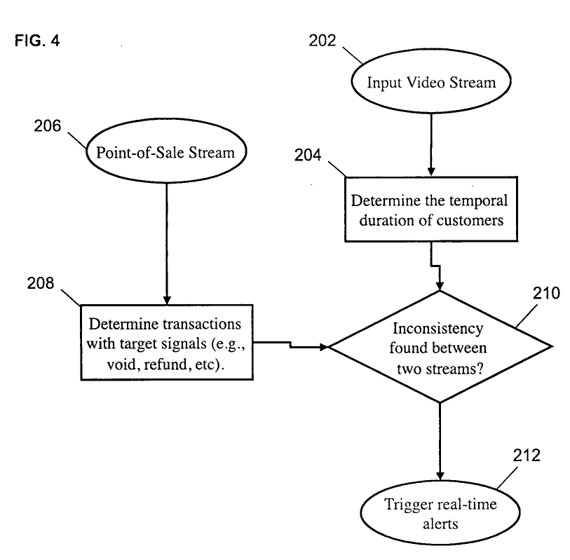

FIGS. 2-3 show a more detailed view of fraud detection tool 153 according to embodiments of the invention. As shown, fraud detection tool 153 comprises an identification component 155 configured to identify a first person (or a first group of people) 130 present within zone of interest 119 at POS device 115 using set of sensor devices 122. To accomplish this, identification component 155 is configured to first establish zone of interest 119 at POS device 115, which may represent an area where customers typically frequent to make purchases, such as an aisle or area within a store. Zone of interest 119 can be determined either manually by a user (e.g., security personnel) via a pointer device, or automatically by dynamically learning the position of a customer near POS 115. In either case, once first person 130 enters zone of interest 119, his/her presence is detected using methods including, but not limited to: background modeling, object detection and tracking, spatial intensity field gradient analysis, diamond search block-based (DSBB) gradient descent motion estimation, or any other method for detecting and identifying objects captured by a sensor device. In the exemplary embodiment shown in FIG. 3, set of sensor devices 122 produces video data from a digital video camera positioned over POS 115 and zone of interest 119. However, it will be appreciated that other embodiments may have any number of sensor devices positioned in different and/or multiple locations.

Once first person 130 enters zone of interest 119 at POS 115, identification component 155, in combination with sensor devices 122, is configured to detect and monitor a set of attributes of first person 130. Specifically, identification component 155 processes sensor data from sensor devices 122 in real-time, extracting attribute metadata from the visual attributes of people that are detected in zone of interest 119. In one embodiment, in which video sensor data is received from a video camera, identification component 155 uploads messages in extensible mark-up language (XML) to a data repository, such as storage system 116 (FIG. 1). Identification component 155 provides the software framework for hosting a wide range of video analytics to accomplish this. The video analytics are intended to detect and track a person or a plurality of people moving across a video image, perform an analysis of all characteristics associated with each person, and extract a set of attributes from each person.

In one embodiment, identification component 155 is configured to relate each of the set of attributes of first person 130 to a canonical customer model 158 using various attributes including, but not limited to, appearance, color, texture, gradients, edge detection, motion characteristics, shape, spatial location, etc. Identification component 155 provides the algorithm(s) necessary to take the data associated with each of the extracted attributes and dynamically map it into tables or groups within an index of customer model 158, along with additional metadata that captures a more detailed description of the extracted attribute and/or person. For example, each attribute within customer model 158 may be annotated with information such as an identification (ID) of the sensor(s) used to capture the attribute, the location of the sensor(s) that captured the attribute, or a timestamp indicating the time and date that the attribute was captured. Customer model 158 can be continuously updated and cross-referenced against POS data to create a historical archive of people and transactions.

Based on the attributes within customer model 158 for first person 130, fraud detection tool 153 is capable of distinguishing between first person 130 and other customers that enter zone of interest 119. In one embodiment, identification component 155 is configured to detect the presence of a second person (or a second group of people) 132 (FIG. 3) within zone of interest 119. Specifically, identification component 155 monitors a set of attributes of second person 132 when second person 132 enters zone of interest 119 at POS device 115, and relates each of the set of attributes of second person 132 to canonical customer model 158. Identification component 155 compares the set of attributes of second person 132 to the set of attributes of first person 130 and determines if a discrepancy exists between the identities of first person 130 and second person 132. If a discrepancy exists (i.e., an abrupt change in the attributes of the customer model is detected), it is determined that second person 132 is now present within zone of interest 119. In one embodiment, an identification of second person 132 present within zone of interest 119 at POS device 115 triggers the end of a time duration that first person 130 is present within zone of interest 119, which started when first person 130 was initially detected entering zone of interest 119.

During operation, customers (e.g., first person 130 and second person 132) enter zone of interest 119 to conduct a transaction at POS device 115, including, but not limited to: a sale (i.e., purchase), refund, void, inquiry (e.g., price check), manager override, etc. Items are typically scanned by scanner 120 as part of the transaction, and POS data for the scanned item(s) and associated transaction type is collected at POS device 115. The POS data is then transmitted to a transaction component 160 of fraud detection tool 153, which is configured to determine whether POS device 115 has performed a first transaction and a second transaction while first person 130 is present within zone of interest 119 at POS device 115.

In one embodiment, transaction component 160 is configured to establish a time duration that first person 130 is present within zone of interest 119 based on the recorded entrance and exit times. This time duration is compared to the timestamps corresponding to the transaction times of each of the first and second transactions. Fraud detection tool 153 comprises an analysis component 165 configured to determine whether the second transaction is potentially fraudulent based on a determination of whether POS device 115 has performed a first transaction and a second transaction while first person 130 is present within zone of interest 119. However, even if POS 115 performs two transactions while first person 130 is present within zone of interest 119, fraud is not necessarily present. Therefore, analysis component 165 is configured to also analyze the transaction type of the first transaction and the second transaction, and detect whether the second transaction is potentially fraudulent based on the analysis of the transaction type of the second transaction. For example, customers may purchase multiple items in separate transactions for any number of personal reasons. However, it is less likely that a customer will purchase an item and immediately desire a refund. Therefore, this may indicate the occurrence of employee error and/or collusion. In this case, the second transaction (i.e., refund) is considered “suspicious” and potentially fraudulent. As such, analysis component 165 is configured to generate an alert if the second transaction is potentially fraudulent. In this way, the appropriate people (e.g., security personnel, managers) can be alerted to the situation.

Further, it can be appreciated that the methodologies disclosed herein can be used within a computer system to detect potentially fraudulent transactions, as shown in FIG. 1. In this case, fraud detection tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

The program modules carry out the methodologies disclosed herein, as shown in FIG. 4. According to one embodiment, at 202, a video input stream is received from a set of sensor devices and analyzed to identify a first person present within a zone of interest at a POS device. At 204, the temporal duration that the first person is present within the zone of interest at the POS device is established. A POS data stream is received at 206, and analyzed at 208 to determine whether the POS device has performed a first transaction and a second transaction, as well as the transaction type for both the first and second transactions. At 210, the POS data stream is compared to the video input stream to determine if an inconsistency exists, i.e., whether the second transaction occurred within the time duration that the first person was present within the zone of interest at the POS device. If an inconsistency exists, a real-time alert is triggered at 212. The flowchart of FIG. 4 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Furthermore, an implementation of exemplary computer system 104 (FIG. 1) may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for detecting fraudulent transactions. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for detecting potentially fraudulent transactions comprising:
identifying a first person present within a zone of interest at a point of sale (POS) device using a set of sensor devices;
determining whether the POS device has performed a first transaction and a second transaction while the first person is present within the zone of interest at the POS device;
analyzing a transaction type of the first transaction and the second transaction; and
detecting whether the second transaction is potentially fraudulent based on the determining and the analyzing.

2. The method according to claim 1 further comprising generating an alert if the second transaction is potentially fraudulent.

3. The method according to claim 1, the identifying comprising:
monitoring a set of attributes of the first person when the first person enters the zone of interest at the POS device; and
relating each of the set of attributes of the first person to a canonical customer model.

4. The method according to claim 3 further comprising establishing a time duration that the first person is present within the zone of interest at the POS device, wherein an identification of a second person present within the zone of interest at the POS device triggers an end of the time duration that the first person is present within the zone of interest at the POS device, and wherein the second person is different than the first person.

5. The method according to claim 4, the identification of the second person comprising:
monitoring a set of attributes of the second person when the second person enters the zone of interest at the POS device;
relating each of the set of attributes of the second person to the canonical customer model; and
comparing the set of attributes of the second person to the set of attributes of the first person.

6. A system for detecting potentially fraudulent transactions comprising:
at least one processing unit;
memory operably associated with the at least one processing unit; and
a fraud detection tool storable in memory and executable by the at least one processing unit, the fraud detection tool comprising:
an identification component configured to identify a first person present within a zone of interest at a point of sale (POS) device using a set of sensor devices;
a transaction component configured to determine whether the POS device has performed a first transaction and a second transaction while the first person is present within the zone of interest at the POS device; and
an analysis component configured to:
analyze a transaction type of the first transaction and the second transaction; and
detect whether the second transaction is potentially fraudulent based on a determination of whether the POS device has performed a first transaction and a second transaction while the first person is present within the zone of interest at the POS device, and an analysis of the transaction type of the second transaction.

7. The fraud detection tool according to claim 6, the analysis component further configured to generate an alert if the second transaction is potentially fraudulent.

8. The fraud detection tool according to claim 6, the identification component further configured to:
monitor a set of attributes of the first person when the first person enters the zone of interest at the POS device; and
relate each of the set of attributes of the first person to a canonical customer model.

9. The fraud detection tool according to claim 8, the identification component further configured to establish a time duration that the first person is present within the zone of interest at the POS device, wherein an identification of a second person present within the zone of interest at the POS device triggers an end of the time duration that the first person is present within the zone of interest at the POS device, and wherein the second person is different than the first person.

10. The fraud detection tool according to claim 9, the identification of the second person comprising:
monitoring a set of attributes of the second person when the second person enters the zone of interest at the POS device;
relating each of the set of attributes of the second person to the canonical customer model; and
comparing the set of attributes of the second person to the set of attributes of the first person.

11. A computer-readable medium storing computer instructions, which when executed, enables a computer system to detect potentially fraudulent transactions, the computer instructions comprising:
identifying a first person present within a zone of interest at a point of sale (POS) device using a set of sensor devices;
determining whether the POS device has performed a first transaction and a second transaction while the first person is present within the zone of interest at the POS device;
analyzing a transaction type of the first transaction and the second transaction; and
detecting whether the second transaction is potentially fraudulent based on the determining and the analyzing.

12. The computer-readable medium according to claim 11 further comprising computer instructions for generating an alert if the second transaction is potentially fraudulent.

13. The computer-readable medium according to claim 11, the identifying further comprising computer instructions for:
monitoring a set of attributes of the first person when the first person enters the zone of interest at the POS device; and
relating each of the set of attributes of the first person to a canonical customer model.

14. The computer-readable medium according to claim 13, the computer instructions for identifying the first person further comprising computer instructions for establishing a time duration that the first person is present within the zone of interest at the POS device, wherein an identification of a second person present within the zone of interest at the POS device triggers an end of the time duration that the first person is present within the zone of interest at the POS device, and wherein the second person is different than the first person.

15. The computer-readable medium according to claim 14, the identification of the second person comprising:
monitoring a set of attributes of the second person when the second person enters the zone of interest at the POS device;
relating each of the set of attributes of the second person to the canonical customer model; and
comparing the set of attributes of the second person to the set of attributes of the first person.

16. A method for deploying a fraud detection tool for use in a computer system that detects potentially fraudulent transactions, the method comprising:
providing a computer infrastructure operable to:
identify a first person present within a zone of interest at a point of sale (POS) device using a set of sensor devices;
determine whether the POS device has performed a first transaction and a second transaction while the first person is present within the zone of interest at the POS device;
analyze a transaction type of the first transaction and the second transaction; and
detect whether the second transaction is potentially fraudulent based on a determination of whether the POS device has performed a first transaction and a second transaction while the first person is present within the zone of interest at the POS device, and an analysis of the transaction type of the second transaction.

17. The method according to claim 16, the computer infrastructure further operable to generate an alert if the second transaction is potentially fraudulent.

18. The method according to claim 16, the computer infrastructure further operable to:
monitor a set of attributes of the first person when the first person enters the zone of interest at the POS device; and
relate each of the set of attributes of the first person to a canonical customer model.

19. The method according to claim 18, the computer infrastructure further operable to establish a time duration that the first person is present within the zone of interest at the POS device, wherein an identification of a second person present within the zone of interest at the POS device triggers an end of the time duration that the first person is present within the zone of interest at the POS device, and wherein the second person is different than the first person.

20. The method according to claim 19, the computer infrastructure operable to identify the second person further operable to:
monitor a set of attributes of the second person when the second person enters the zone of interest at the POS device;
relate each of the set of attributes of the second person to the canonical customer model; and
compare the set of attributes of the second person to the set of attributes of the first person.
